(19) United States
(12) Patent Application Publication
(10) Pub. No.: US 2017/0282860 A1
(43) Pub. Date: Oct. 5, 2017

(54) WIPER SYSTEM FOR A MOTOR VEHICLE

(71) Applicant: GM GLOBAL TECHNOLOGY OPERATIONS LLC, Detroit, MI (US)

(72) Inventors: Udo MILDNER, Ruesselsheim (DE); Lothar TESKE, Ruesselsheim (DE); Jose SOUSA DIAS, Ruesselsheim (DE)

(73) Assignee: GM GLOBAL TECHNOLOGY OPERATIONS LLC, Detroit, MI (US)

(21) Appl. No.: 15/473,247

(22) Filed: Mar. 29, 2017

(30) Foreign Application Priority Data
Mar. 29, 2016 (DE) 102016003790.3

(51) Int. Cl. B60S 1/04

(52) U.S. Cl. CPC B60S 1/0433; B60S 1/0419; B60S 1/0441

(57) ABSTRACT

A wiper system is disclosed for a motor vehicle, and includes a longitudinally extended multi-part support having first and second longitudinally extended support arms. The second support arm is oriented in an imaginary extension to the first support arm and connected to the first support arm. A fastening element for fastening the support to a body of the motor vehicle is in each case arranged on the longitudinal ends, which face away from one another, of first and second support arm. A first wiper bearing is arranged on at least one of the longitudinal ends of first and second support arm.

### CROSS-REFERENCE TO RELATED APPLICATIONS

This application claims priority to German Patent Application No. 102016003790.3, filed Mar. 29, 2016, which is incorporated herein by reference in its entirety.

### TECHNICAL FIELD

The present disclosure relates to a wiper system for arrangement on a motor vehicle, which is configured as co-rotating wiper system, a motor vehicle body equipped with such a wiper system as well as for a corresponding motor vehicle.

### BACKGROUND

Wiper systems for motor vehicles serve to clean front or rear windscreens of motor vehicles. For frontally provided wiper systems, provision is made for the most part for two wiper arms, which can be moved in pendulum fashion and which free a wiping area of the windscreen from water and/or dirt by corresponding wiper blades. An axial body for a wiper system device of a motor vehicle includes a pivot bearing mount, in which a wiper arm spindle can be pivotably supported, for example as disclosed in DE 10 2011 121 898 A1. Holders in an area of a spring top mounting and a further spring top mounting can be assigned to the body hereby. Such holders are configured to be comparatively stiff, so that forces can be transferred between the spring top mountings of the motor vehicle body via a cross member.

### SUMMARY

In accordance with the present disclosure an improved wiper system is provided, which can be configured equally for left-hand drive vehicles as well as for right-hand drive vehicles having relatively few parts for installation in a motor vehicle, which can be produced in a particularly cost-efficient and production-economic manner. In addition, the wiper system is configured to stabilize and reinforce the motor vehicle body and to reduce the weight of the motor vehicle.

The wiper system is provided for arrangement in a motor vehicle. It has a longitudinally extended multi-part support. The multi-part support has a first longitudinally extended support arm and a second longitudinally extended support arm. The second support arm is oriented and arranged in an imaginary extension to the first support arm. It is further connected to the first support arm. A fastening element for fastening the support to a body of the motor vehicle is in each case arranged on the longitudinal ends, which face away from one another, of first and second support arm, thus on the longitudinal ends or exteriors, which face away from one another, of the support.

A first wiper bearing is further arranged on at least one of the longitudinal ends, which face one another, of first and second support arm. The first wiper bearing is a bearing for a wiper arm of the wiper system, and serves for the pivotable support of a wiper arm located on the inside in relation to the transverse vehicle direction. An external wiper arm of the wiper system can be arranged elsewhere on the motor vehicle body or on the support of the wiper system. Advantageously, the support is embodied by the first and by the second support arm. The longitudinal ends, which face away from one another, of first and second support arm coincide with the outer ends, which face away from one another, of the support.

The longitudinal ends of first and second support arm, which face away from one another, of the support, can be fastened to opposite left and right support structure components of the body. For example, the fastening elements provided on the ends, which face away from one another, of the support or of the support arms, can be arranged on and fastened to a left and a right front suspension strut top mounting of the motor vehicle body. The support can fulfill a double function in this respect. On the one hand, it acts as support for at least one wiper bearing, which, in relation to the transverse vehicle direction (y), is located between the left and the right vehicle side. On the other hand, the multi-part support can act as strut, which couples the suspension strut mounts or suspension strut top mountings located opposite one another in transverse vehicle direction (y) to one another and strengthens them. A material, component and weight reduction results from that functional integration.

Provision is typically made for the first and the second support arm to be embodied of different lengths. While the outer or longitudinal ends, which face away from one another, of first and second support arm, can be arranged quasi symmetrically on the left and on the right side of a motor vehicle body, the first wiper bearing, which is provided on the longitudinal ends of first and second support arm, is located eccentrically on or in the motor vehicle, relative to the transverse vehicle direction. Due to the fact that the first wiper bearing is arranged on at least one of the longitudinal ends of first and second support arm and is fastened thereto, the entire wiper system, in particular the assembly of the multi-part support and of the first wiper bearing arranged thereon can be configured for a right-hand drive vehicle as well as for a left-hand drive vehicle.

The arrangement of the first wiper bearing on a longitudinal end of first and/or second support arm located on the inside in relation to the transverse vehicle direction, provides for at least two different arrangements of the first wiper bearing when using identical first and second support arms. For a right-hand drive vehicle, provision can be made for an arrangement of first and second support arm, which is reversed or interchanged, respectively, as compared to a left-hand drive vehicle. The first wiper bearing is in each case located in the transition area between first and second support arm. If first and second support arms are embodied of different lengths, different positions, which are in each case provided for a left-hand drive configuration or right-hand drive configuration, result for the first wiper bearing in transverse vehicle direction (y).

According to a further development, provision is made for the first support arm and the second support arm to be connected to one another via the first wiper bearing. The first wiper bearing hereby acts as connecting component or as tie between the first support arm and the second support arm. Provision can be made for the first and the second support arm to be tubularly embodied and for the first wiper bearing to at least sectionally have a tubular or pin-like connecting body or connecting section, by which an end of the first support arm located on the inside in transverse vehicle direction as well as an end of the second support arm located on the inside in transverse vehicle direction can be connected structurally, i.e. to transfer loads.

According to a further development, the first wiper bearing has a connecting body, which extends between the longitudinal ends of first and second support arm. It is possible that the first wiper bearing has two plug-in pins, which point in opposite directions and which can be inserted into the open ends, which face one another, of the tubular first and second support arms, and can for example be pressed therewith. The first wiper bearing, in particular, the connecting body thereof or the connecting section thereof, can be arranged between the first and the second support arm in relation to the longitudinal direction of first and/or second support arm. The first wiper bearing can thus act as joining or connecting element between first and second support arm.

According to a further embodiment, the first wiper bearing further has a bearing section, which protrudes laterally away from the connecting body, including a bearing bushing, which is embodied for receiving a wiper spindle. After arrangement of the wiper system on the motor vehicle, the bearing bushing acts as rotatable bearing for the spindle of a wiper arm of the wiper arm located on the inside in relation to the transverse vehicle direction (y). In relation to a cylinder or pipe geometry of first and/or second support arm, the bearing section protrudes radially outwards from the support arm. This provides for a relatively simple and intuitive assembly of the wiper spindle and of the wiper arm of the wiper system.

Provision may be made for different wiper bearings for a right-hand drive vehicle configuration and for a left-hand drive vehicle configuration. The first wiper bearing of a left-hand drive configuration can, for example, be configured mirror-symmetrically to the first wiper bearing of a right-hand drive configuration. The first and the second support arm as well as the fastening elements can be used for a left-hand drive configuration as well as for a right-hand drive configuration. Many same parts can thus be used for differently configured vehicles. Storage and logistics costs as well as the logistics effort for an optionally left-hand drive or right-hand drive embodiment can thus be reduced.

According to a further embodiment, at least one of the fastening elements has a second wiper bearing. It is further possible that at least one of the fastening elements is connected in one piece to a second wiper bearing. The integration of a second wiper bearing in at least one of the fastening elements provides for a further component and weight reduction. On the one hand, the support can at least be fastened on one side of the motor vehicle by only a single fastening element. At the same time, a second wiper bearing can be provided for a second wiper spindle, thus for a second wiper arm, in the area or in the direct vicinity of the fastening location. The integration of a second wiper bearing in at least one of the fastening elements is advantageous for a particularly stable and permanent fastening of the wiper bearing to the motor vehicle body. The second wiper bearing can hereby be arranged on the motor vehicle body in the direct vicinity of the fastening location of the support therethrough.

According to a further embodiment, each of the two fastening elements has a second wiper bearing. In the alternative, each of the two fastening elements can be connected to the second wiper bearing in one piece. For a typical wiper system including two wiper arms, this appears to be superfluous at first glance, because a total of three wiper bearings, namely a first wiper bearing between first and second support arm, and two second wiper bearings are provided by first and second support arm on the exteriors located in transverse vehicle direction in this manner.

However, it turns out to be advantageous for a variable left-hand drive or right-hand drive embodiment, which can be selectively configured, when both fastening elements, which are to be provided on the opposite exteriors of the support, are in each case provided with a second wiper bearing. In the case of a left-hand drive embodiment, only the second wiper bearing provided on the left outer end of the support acts as bearing for a second wiper spindle. In the case of a right-hand drive vehicle, only the second wiper bearing provided on the right exterior of the support acts as bearing for a second wiper spindle, thus for a wiper arm.

The first wiper arm is in each case pivotable arranged on the first wiper bearing, which is arranged to be offset to the center of the vehicle. Due to the general provision of a second wiper bearing on each of the two fastening elements, identical fastening elements can in each case be used for a right-hand drive configuration as well as for a left-hand drive configuration of the wiper system. The multitude of components can be reduced in this manner.

According to a further embodiment, the fastening elements in each case have a connecting section for connection to one of the support arms, a fastening section for fastening to the body, and a bearing section including a bearing bushing embodied for receiving a wiper spindle. The respective fastening element can be fastened to the body of the motor vehicle by the fastening section. The fastening element can be connected to the support of the wiper system to an outer end of one of first or second support arm by the connecting section and, with the bearing section, the fastening element serves to support a wiper spindle of one of the two wiper arms of the wiper system, typically of a second wiper arm. In this respect, the fastening element provides three different functions.

Provision may be made for the fastening element, which is to be arranged on the right body side, to be embodied mirror-symmetrically to the fastening element, which is to be arranged on the left body side. A mirror-symmetrical or largely identical arrangement, respectively, of the longitudinal ends, which face away from one another, of the support, can be attained on the motor vehicle body in this manner.

According to a further embodiment, provision is further made for opposite longitudinal ends of the first support arm and for opposite longitudinal ends of the second support arm to be capable of optionally being connected to one of the fastening elements or to the first wiper bearing. Depending on whether the wiper system is designed for a left-hand drive vehicle or for a right-hand drive vehicle, different orientations or arrangements, respectively, of first and second support arm can result. Provision can be made for each longitudinal end of first and second support arm to be capable on principle of being connected to the wiper bearing as well as to one of the fastening elements to a connecting section of the fastening elements. However, it is on principle also sufficient, when a longitudinal end of first and second support arm can in each case be connected exclusively to a fastening element, and when an opposite longitudinal end of first and second support can be connected exclusively to the first wiper bearing.

For the alternating connection of support arms and the first wiper bearing, provision is made for positive and/or non-positive connecting mechanisms. It is possible that the opposite longitudinal ends of first and/or second support arm in each case have a connecting bushing for receiving a connecting section of a fastening element or of the first wiper bearing. The connecting sections can be designed as locking pins, for example, which can be inserted into a bushing on the end section of the first and/or second support arm.

On principle, however, a reverse arrangement and embodiment of bushings and locking pins is also possible on the support arms, fastening elements and on the wiper bearing. The longitudinal ends of the support arms can thus be embodied as locking pins and fastening sections of the fastening elements or of the first wiper bearing corresponding herewith can be embodied in a bushing-like manner.

In addition to this, it is possible that the overlapping arrangement of connecting sections and longitudinal ends of the support arms are pressed with one another for a permanent, positive connecting mechanism. Provision can also be made for this purpose for common punching, stamping, riveting methods or also an electromagnetic forming method.

According to a further embodiment, the first support arm has a shorter longitudinal extension than the second support arm. The embodiments of first and second support arm with different lengths results in an eccentric arrangement of the first wiper bearing for a left-hand drive vehicle as well as for a right-hand drive vehicle. For a left-hand drive vehicle, provision is made to arrange the first support arm on the left of the motor vehicle and to arrange the second support arm on the right of the motor vehicle and to then connect first and second support arms to one another via the wiper bearing located therebetween, in particular the connecting bodies thereof.

In contrast, for a right-hand drive configuration provision is made to arrange the first support arm on the right of the motor vehicle and to arrange the second support arm on the left of the motor vehicle in a corresponding manner. The first as well as the second support arm can be used identically for both vehicle alternatives.

According to a further embodiment, the wiper system further has a drive as well as a first and a second wiper spindle. The wiper system is further provided with a coupling rod, via which the first and the second wiper spindle are in operative connection with the drive running in parallel or synchronously, respectively. The wiper system is embodied as co-rotating wiper system, in the case of which the first and the second wiper arm, which are in each case arranged on the first and on the second wiper spindle, can be moved in parallel and in a co-rotating manner in pendulum fashion. The drive, the coupling rod as well as first and second wiper spindle are arranged on the support. In this respect, the support cannot only serve to support and fasten the first wiper bearing, but virtually all components of the wiper system.

According to a further development, provision is further made for the drive and the coupling rod to be arranged on the first support arm. The drive and the coupling rod are thus typically located between the first and the second wiper bearing, relative to the transverse vehicle direction. Such an arrangement is extremely space-saving for the co-rotating drive of the first and of the second wiper spindle.

According to a further embodiment of the wiper system, the latter can be configured optionally for a left-hand drive vehicle or for a right-hand drive vehicle. For a left-hand drive vehicle, the first support arm can be fastened to a left side of the body. For a right-hand drive vehicle, in contrast, the first support arm can be fastened to a right side of the body. For both vehicle alternatives, the first support arm is in each case supported on an opposite side of the body via the second support arm. The first support arm can thus experience a mechanical support and stabilization on the opposite body side via the second support arm.

According to a further aspect, provision is finally made for a motor vehicle body, which has an above-described wiper system in its front area, in particular in the area of a front carriage, that is, located in front of a passenger compartment. The motor vehicle body can hereby be embodied arbitrarily as left-hand drive vehicle or as right-hand drive vehicle body. The wiper system and its individual components can hereby be configured accordingly. In this respect, the wiper system can be used arbitrarily for left-hand drive vehicles as well as for right-hand drive vehicles.

According to a further embodiment of the motor vehicle body, the latter has two front suspension strut top mountings, which are spaced apart from one another in transverse vehicle direction. The longitudinal ends, which face away from one another, of first and second support arm of the support of the wiper system, are arranged on the suspension strut top mountings. The support arms and thus also the support are embodied to be compression-resistant as well as tension-resistant. In this respect, the support of the wiper system can provide a stabilizing and reinforcing coupling between the left suspension strut top mounting and the right suspension strut top mounting of the motor vehicle body. At the same time, the wiper system can be fastened to the motor vehicle body in a particularly stable manner by it support, which is arranged directly on the two opposite suspension strut top mountings.

It follows from the foregoing that provision is finally made for a motor vehicle including an above-described motor vehicle body. In this respect, the motor vehicle can be embodied as left-hand drive motor vehicle as well as as right-hand drive motor vehicle. The wiper system provided on its body can have a corresponding left-hand drive or right-hand drive configuration, which consists of identical individual parts for the left-hand drive alternative as well as for the right-hand drive alternative.

### BRIEF DESCRIPTION OF THE DRAWINGS

The present disclosure will hereinafter be described in conjunction with the following drawing figures, wherein like numerals denote like elements.

FIG. 1 shows a side view of a motor vehicle embodied as passenger vehicle;

FIG. 2 shows a perspective isolated illustration of the basic structure of a wiper system embodied for a left-hand drive vehicle;

FIG. 3 shows an illustration, which corresponds to FIG. 2, but for a right-hand drive vehicle;

FIG. 4 shows a further illustration of the wiper system according to FIG. 2, but with drive and coupling rods;

FIG. 5 shows an enlarged illustration of the illustration according to FIG. 4;

FIG. 6 shows a perspective illustration of a front area of a body-in-white without wiper system; and

FIG. 7 shows an illustration according to FIG. 6, but with a wiper system according to FIG. 4 arranged thereon.

### DETAILED DESCRIPTION

The following detailed description is merely exemplary in nature and is not intended to limit the present disclosure or the application and uses of the invention. Furthermore, there is no intention to be bound by any theory presented in the preceding background of the invention or the following detailed description.

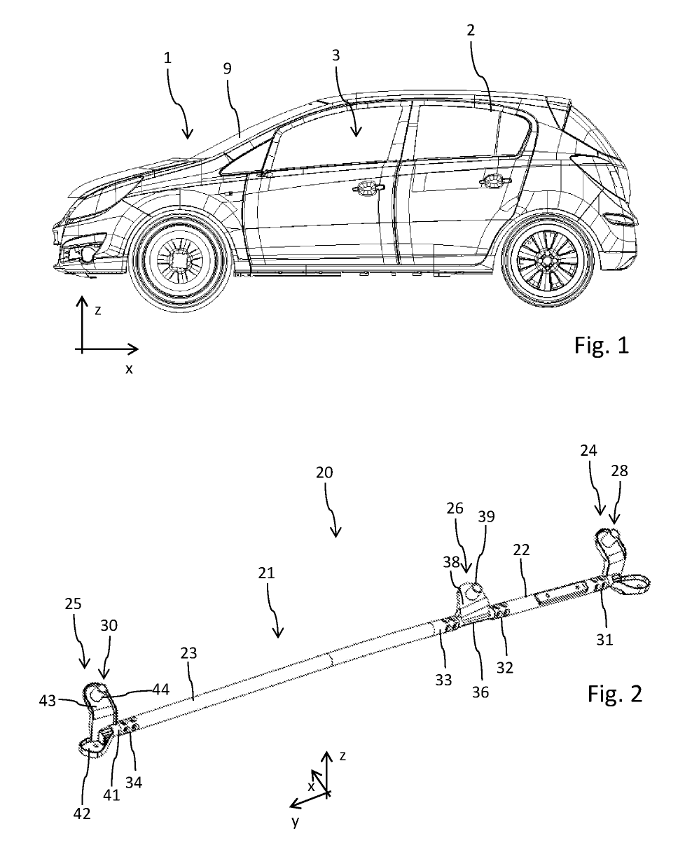

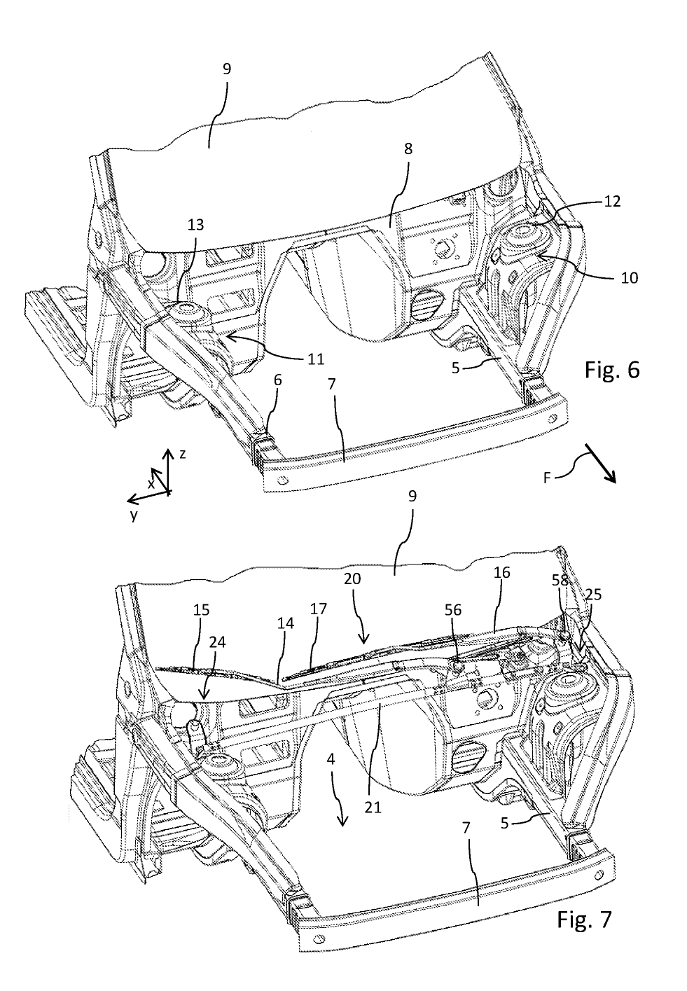

The motor vehicle 1 shown in FIG. 1 is embodied as passenger vehicle. It has a self-supporting motor vehicle body 2 including an interior 3, which acts as passenger compartment. The front carriage 4 of the motor vehicle body 2 is shown in FIGS. 6 and 7 in perspective illustration. The arrow F hereby specifies the direction of motion of the motor vehicle. The front carriage 4 serves for receiving a front engine (not shown). The front carriage 4 has two longitudinally extending longitudinal supports 5, 6, which run parallel to one another and which are arranged on the left and on the right side of the vehicle. The ends of the longitudinal supports 5, 6, which emerge forwards from a front wall 8, are structurally connected to one another via a bumper cross beam 7.

In the transition area to the front wall 8, which separates the engine compartment and the interior 3 from one another, provision is made above the longitudinal supports for a left suspension strut mount 10 and a right suspension strut mount 11. The suspension strut mounts 10, 11 are supported on the respective left and right longitudinal support 5, 6 from the top. On their upper end, the suspension strut mounts 10, 11 in each case have a suspension strut top mounting 12, 13. The suspension strut top mountings 12, 13 serve to receive and fasten a suspension strut, which is connected to the undercarriage of the motor vehicle 1.

As illustrated in FIG. 7, a wiper system 20 is provided in the foot area of a front windscreen 9. The wiper system 20 has a first wiper arm 14 and a second wiper arm 16. On the free end, which faces away from a respective wiper spindle 56, 58, the wiper arms 14, 16 in each case have a wiper blade 15, 17, which rests against the windscreen 9 on the outside and which remove water located on the outside of the windscreen 9 during operation of the wiper system 20, in response to a movement of the wiper arms 14, 16 in pendulum fashion.

The wiper system 20 is illustrated separately in FIGS. 2, 4 and 5, partly in an enlarged manner. The wiper system 20 has a longitudinally extended support 21. The longitudinally extended support 21 has a first support arm 22 as well as a second support arm 23. First and second support arm 22, 23 are arranged in alternating extension relative to one another. First and second support arm 22, 23 can be embodied as support pipes. They extend substantially parallel to one another. The second support arm 23 is in an imaginary extension to the longitudinal direction of the first support arm 22. Vice versa, the first support arm 22 is in an imaginary extension to the longitudinal orientation of the second support arm 23.

First and second support arm 22, 23 are fixedly connected to one another. The first support arm 22 and the second support arm 23 form the continuous longitudinally extended support 21. Due to the alternating fastening of first and second support arm 22, 23, the support is embodied to be compression-resistant as well as tension-resistant.

Fastening elements 24, 25 are in each case arranged on the exteriors, in particular on the end sections 31, 34, which face away from one another, of the support 21. The fastening element 24 is embodied as left fastening element. It is located on a left outer end of the support 21. The right fastening element 25 is embodied as right fastening element. It is accordingly located on a right outer end of the support 21. The fastening elements 24, 25 are fixedly connected to the support 21, thus to the respective support arms 22, 23.

The fastening elements 24, 25 serve for fastening to the body 2, in particular to the suspension strut top mountings 12, 13. Due to the fact that the fastening elements 24, 25 are fixedly connected to the support 21 and due to the fastening elements 24, 25 being fixedly connected to the suspension strut top mountings 12, 13, the support 21 of the wiper system 20 provide a connection, which is tension-resistant as well as compression-resistant, between the left and right suspension strut top mountings 12, 13. The body 2, thus the front carriage 4, can experience an additional strengthening and reinforcement in this respect.

As illustrated in FIGS. 2 and 5, the first support arm 22 and the second support arm 23 are connected to one another via a first wiper bearing 26. The first wiper bearing 26 has a connecting body 36 or a corresponding connecting section, respectively. Ends 32, 33, which face one another, of first support arm 22 and second support arm 23 are connected to one another by the connecting body 36. The connecting body 36 can have two insertion sections or locking pins, which can be inserted into bushings corresponding herewith on the longitudinal ends 32, 33 of first support arm 22 and second support arm 23.

The first and the second support arms 22, 23 can then be punched or pressed with the first wiper bearing 26, in particular with the connecting body 36 thereof. FIG. 5 shows the individual punching locations 60. They can be realized by electromagnetic forming, for example. The first support arm 22, the first wiper bearing 26 as well as the second support arm 23 are permanently connected to one another in a positive and/or non-positive manner in this way.

As is further shown in FIG. 5, the first wiper bearing 26 has a bearing section 38, which protrudes radially outwards from the connecting body 36 or upwards, respectively. In particular, a cylindrical bearing busing 39 is embodied in the bearing section 38. The bearing bushing serves to receive and rotatably support a wiper spindle 56. Provision is furthermore made between the opposite longitudinal ends 31, 32 of the first support arm 22 for a fastening rail 61 for the fastening of a drive 50 and for the fastening of a coupling rod 51 to the first support arm 22. The coupling rod 51 has a plurality of rods and joints. It is connected to the drive 50 via a crank 62. The coupling rod 51 is coupled to a first wiper spindle 56 as well as to a second wiper spindle 58. The first wiper arm 14 is arranged on the first wiper spindle 56 in a rotatably fixed manner, while the second wiper arm 16 is arranged on the second wiper spindle 58 in a rotatably fixed manner.

The fastening element 24 on the left longitudinal end 31 of the first support art 22 shown in FIG. 5 in an enlarged manner has a connecting section 41, a fastening section 42 and a bearing section 43. The connecting section 41 can be embodied in the form of a locking pin, which, similarly to the connecting body 36, is pressed or punched with a bushing on the left longitudinal end 31 of the first support arm 22. Corresponding punching locations 60 are also illustrated there. Being connected to the connecting section 41 in one piece, the fastening element 24 has a prolate or flattened fastening section 42 including individual passage openings 63. Those passage openings 63 serve to receive fastening means, for instance in the form of fastening screws, for connecting or screw-connecting, respectively, the fastening element 24 in an area of its fastening section 24, for example, to the left suspension strut top mounting 12.

Similar to the bearing section 38, the fastening element 24 also has a bearing section 43, which protrudes radially and upwards from the connecting section 41 and which is embodied to be largely flat, including a bearing bushing 44. The second wiper spindle 58 of the wiper system 20 is rotatably supported in that bearing bushing 44. The fastening element 24 thus acts as second wiper bearing 28.

The fastening element 25 provided on the other or opposite longitudinal end 34, respectively, of the second support arm 23, is embodied largely identical to the fastening element 24. It also has a connecting section 41, a fastening section 42 and a bearing section 43 including a bearing bushing 44, which is embodied for receiving the second wiper spindle 58. The fastening element 25 thus also acts as second wiper bearing 30.

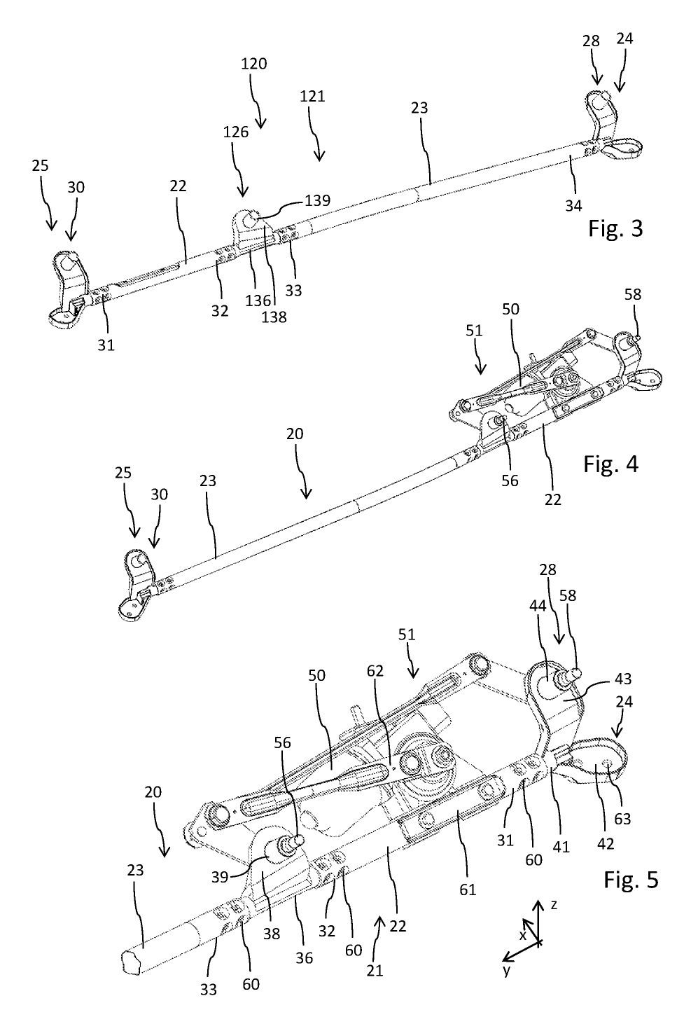

Even though a bearing bushing 44 is provided on the right fastening element 24 in the left-hand drive embodiment of the wiper system 20 shown in FIGS. 2, 4 and 5, the bearing bushing is inoperable in that embodiment. All the supporting components of the wiper system 20, namely the first support arm 22, the second support arm 23 as well as the fastening elements 24, 25, can equally also be used for a wiper system 120, which is illustrated in an exemplary manner in FIG. 3, which is embodied for a right-hand drive vehicle. The components of the wiper system 20, which have already been described with regard to the left-hand drive alternative, are shown here by using identical reference numerals.

The arrangement of the fastening elements 24, 25 of the wiper system 120 according to FIG. 3 is identical to the embodiment of the left-hand wiper system 20 according to FIG. 2. The positions of the first and second support arms 22, 23, however, are interchanged. The first and second support arms 22, 23 were further rotated about a central transverse axis by 180°. The longitudinal end 31 of the first support arm 22 is now connected to the fastening element 25. The opposite longitudinal end 32, which faces the second support arm 23, is connected to the first wiper bearing 126. A longitudinal end 33 of the second support arm 23, which faces the first support arm 22, is also connected to the first wiper bearing 126, and an opposite longitudinal end 34 of the second support arm 23 is connected to the left fastening element 24. Compared to the left-hand drive or right-hand drive configurations, respectively of the wiper systems 20, 120 shown in FIGS. 2 and 3, only the first wiper bearing 26, 126 has been exchanged. Compared to the first wiper bearing 26, the wiper bearing 126 has a mirror-symmetrical embodiment or mirror-symmetrical configuration, respectively.

That first wiper bearing 126 also has a connecting body 136, which extends between the longitudinal ends 32, 33 from the first and second support arm 22, 23, as well as a bearing section 138, which protrudes radially therefrom, including a bearing bushing 139 for the first wiper spindle 56.

As becomes clear from a comparison of FIGS. 2 and 3, all remaining support structure components of a wiper system 20 configured for a left-hand drive vehicle can likewise be used for a right-hand drive wiper system 120 by a different assembly. In the configuration according to FIG. 3, the first and second support arms 22, 23 form a longitudinally extended support 121, which serves to reinforce and strengthen the suspension strut top mountings 12, 13 of the front carriage 4 of the vehicle body 2.

While the right one of the two second wiper bearings 30 is inoperable in the configuration of FIG. 2, it is used as wiper bearing for a second wiper arm 16 for a right-hand drive alternative according to FIG. 3. In this case, the left second wiper bearing 28 is then inoperable.

The two respective outer wiper bearings 28, 30, which also act as bearing housing, can be used for both wiper alternatives, i.e. for left-hand drive or right-hand drive vehicles. The wiper spindle 58 remains the same for both wiper alternatives and only needs to be mounted specifically to the respective wiper alternative on one of the two outer wiper bearings 28, 30. The wiper bearings 26, 28, 30 can be made as light metal cast part, for example of aluminum or magnesium or as plastic injection molded part, for example of polypropylene (PP) or polyamide (PA), thus, e.g., with a glass fiber portion of 30 to 50%. In a preferred embodiment, the support 21, thus the first and the second support arm 22, 23, are made as extruded light metal pipe of aluminum or magnesium. In the alternative, at least one of the support arms 22, 23 can be made of a rolled and welded steel pipe.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A wiper system for arrangement on a motor vehicle comprising:
a longitudinally extended multi-part support including a first longitudinally extended support arm and a second longitudinally extended support arm oriented in an imaginary extension to the first support arm and connected to the first support arm;
first and second fastening elements configured to fasten the multi-part support to a body of the motor vehicle, wherein the fastening elements are arranged on longitudinal ends, which face away from one another, of first and second support arm, respectively; and
a first wiper bearing arranged on one of the longitudinal ends of first and second support arm.

17. The wiper system according to claim 16, wherein the first support arm and the second support arm are connected to one another with the first wiper bearing.

18. The wiper system according to claim 17, wherein the first wiper bearing comprises a connecting body extending between the longitudinal ends of the first and second support arms facing one another, of first and second support arm.

19. The wiper bearing according to claim 18, wherein the first wiper bearing further comprises a bearing section protruding laterally away from the connecting body and having a bearing bushing configured to receive a wiper spindle.

20. The wiper system according to claim 16, further comprising a second wiper bearing, wherein at least one of the fastening elements is connected in one piece to the second wiper bearing.

21. The wiper system according to claim 16, further comprising a second wiper bearing, wherein the first wiper bearing is connected to the first fastening element and the second wiper bearing is connected to the second fastening element.

22. The wiper system according to claim 16, wherein the fastening elements comprise a connecting section for connection to one of the support arms, a fastening section for fastening to the body, and a bearing section including a bearing bushing configured to receive a wiper spindle.

23. The wiper system according to claim 16, wherein an opposite longitudinal end of the first support arm and an opposite longitudinal end of the second support arm are configured to be selectively connected to one of the fastening elements or the first wiper bearing.

24. The wiper system according to claim 16, wherein the first support arm has a first longitudinal extension that is shorter than a second longitudinal extension of the second support arm.

25. The wiper system according claim 16, further comprising a drive having a first wiper spindle and a second wiper spindle, which is in operative connection running in parallel with the drive.

26. The wiper system according to claim 25, further comprising a coupling rod, wherein the drive is arranged on the first support arm via the coupling rod.

27. The wiper system according to claim 16, wherein the wiper system is configurable for a left-hand drive vehicle or for a right-hand drive vehicle, wherein for a left-hand drive vehicle, the first support arm is configured to be fastened to a left side of the body and wherein for a right-hand drive vehicle, the first support arm is configured to be fastened to a right side of the body, and wherein the first support arm is in each case supported on an opposite side of the body via the second support arm.

28. A motor vehicle body comprising a body component and a wiper system according to claim 16 fastened to the body component.

29. The motor vehicle body according to claim 28, wherein the body component comprises first and second front suspension strut top mountings, which are spaced apart from one another in transverse vehicle direction (y), wherein the longitudinal ends of the first and second support arm, which face away from one another, are fastened to the first and second front suspension strut top mountings.

30. A motor vehicle comprising a motor vehicle body according to claim 29.
